(19) United States
(12) Patent Application Publication
(10) Pub. No.: US 2014/0073350 A1
(43) Pub. Date: Mar. 13, 2014

(54) USER TERMINAL AND METHOD FOR PROVIDING SERVICE FOR ESTIMATING LOCATION BASED ON CHANGE IN STATE OF USER TERMINAL

(71) Applicant: SAMSUNG ELECTRONICS CO., LTD., Suwon-si (KR)

(72) Inventors: Yong KIM, Seoul (KR); Seong Eun KIM, Suwon-si (KR); Eung Sun KIM, Suwon-si (KR); Hyun Gi AHN, Incheon (KR); Ji Hyun YOON, Yongin-si (KR)

(73) Assignee: SAMSUNG ELECTRONICS CO., LTD., Suwon-si (KR)

(21) Appl. No.: 14/013,782

(22) Filed: Aug. 29, 2013

(30) Foreign Application Priority Data
Sep. 11, 2012 (KR) 10-2012-0100283

(51) Int. Cl. H04W 4/02

(52) U.S. Cl. CPC H04W 4/025
USPC 455/456.1

(57) ABSTRACT

A user terminal and a method for providing a service for estimating a location based on a change in a state of the user terminal, are provided. The method includes sensing a change in a state of a terminal while an application that provides the service of estimating the location is being executed, and extracting one or more resources affected by the change from a plurality of resources to be used to provide the service. The method further includes filtering data corresponding to the one or more affected resources, and providing data to the application based on the filtering.

### CROSS-REFERENCE TO RELATED APPLICATION(S)

This application claims the benefit under 35 U.S.C. §119(a) of Korean Patent Application No. 10-2012-0100283, filed on Sep. 11, 2012, in the Korean Intellectual Property Office, the entire disclosure of which is incorporated herein by reference for all purposes.

### BACKGROUND

1. Field

The following description relates to a user terminal and a method for providing a service for estimating a location based on a change in a state of the user terminal.

2. Description of Related Art

In a method of estimating a location based on mobile communication signals, triangulation may be performed by employing a proximity scheme of approximating a location of a mobile terminal capable of a mobile communication based on a location of a cell base station to which the mobile terminal is connected. Alternatively, triangulation may be performed by measuring times of arrivals (TOAs) of signals from at least three proximate base stations, respectively.

In a method of estimating a location based on a local area network (LAN), a location of a LAN terminal may be estimated by employing a proximity scheme of approximating the location of the LAN terminal based on a location of an access point (AP) to which the LAN terminal belongs. Alternatively, the location of the LAN terminal may be estimated by measuring a signal intensity at a proximate AP, and performing pattern matching with a fingerprint map previously-recorded.

In a method of estimating a location based on an ultra-wide band (UWB) communication, triangulation may be performed by measuring a distance to an AP generating a UWB signal.

In a method of estimating a location based on a magnetic field map, a location of a terminal may be calculated by measuring a magnetic field at the location of the terminal. Methods of calculating and estimating a location of a terminal may include, for example, a Kalman filter, a particle filter, and a Markov localization. The aforementioned methods may include measuring environmental variables that change in various manners when the terminal moves, and estimating the location of the terminal based on a result of the measuring.

### SUMMARY

In one general aspect, there is provided a method of providing a service of estimating a location, the method including sensing a change in a state of a terminal while an application that provides the service of estimating the location is being executed, and extracting one or more resources affected by the change from a plurality of resources to be used to provide the service. The method further includes filtering data corresponding to the one or more affected resources, and providing data to the application based on the filtering.

In another general aspect, there is provided a terminal including a sensing unit configured to sense a change in a state of the terminal while an application that provides a service of estimating a location is being executed, and a processor configured to extract one or more resources affected by the change from a plurality of resources to be used to provide the service. The processor is further configured to filter data corresponding to the one or more affected resources, and provide data to the application based on the filtering.

Other features and aspects will be apparent from the following detailed description, the drawings, and the claims.

### BRIEF DESCRIPTION OF THE DRAWINGS

FIG. 1 is a block diagram illustrating an example of a user terminal that provides a service of estimating a location based on a change in a state of the user terminal.

FIG. 2 is a flowchart illustrating an example of a method of providing a service of estimating a location based on a change in a state of a user terminal.

FIG. 3 is a flowchart illustrating another example of a method of providing a service of estimating a location based on a change in a state of a user terminal.

FIG. 4 is a flowchart illustrating still another example of a method of providing a service of estimating a location based on a change in a state of a user terminal.

FIG. 5 is a block diagram illustrating another example of a user terminal that provides a service of estimating a location based on a change in a state of the user terminal.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, description of well-known functions and constructions may be omitted for increased clarity and conciseness.

Hereinafter, the term “user terminal” may be used to refer to one or more electronic devices capable of estimating a location of a terminal, using a magnetic sensor, an inertial measurement unit (IMU) sensor, and/or other sensors known to one of ordinary skill in the art. The electronic devices may include, for example, a laptop, a personal digital assistant (PDA), a plasma display panel (PDP), and a mobile terminal including a smart phone, a feature phone, and/or other terminals known to one of ordinary skill in the art.

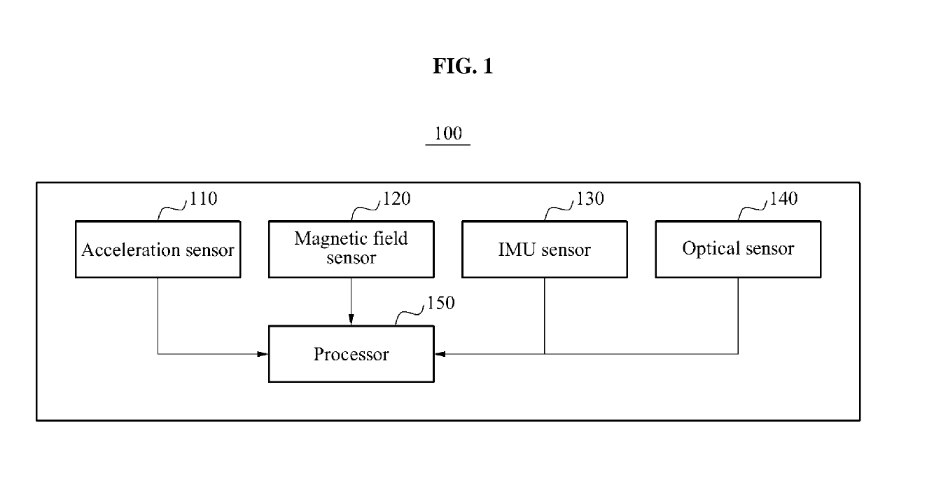

FIG. 1 is a block diagram illustrating an example of a user terminal 100 that provides a service of estimating a location based on a change in a state of the user terminal 100. Referring to FIG. 1, the user terminal 100 may be installed with an application that provides the service of estimating the location.

The user terminal 100 may include one or more resources to be used to provide the service of the application. As shown in the example of FIG. 1, the resources include an acceleration sensor 110 configured to measure an acceleration of the user terminal 100, and a magnetic field sensor 120 configured to measure a magnetic field at a location of the user terminal 100. The resources further include an inertial measurement unit (IMU) sensor 130 configured to measure an acceleration and a gyro value of the user terminal 100, and an optical sensor 140 configured to measure a light-intensity with respect to the user terminal 100, and other values known to one of ordinary skill in the art.

The magnetic field sensor 120 may be further configured to measure a magnetic field of each of three axes including an x-axis, a-y axis, and a z-axis. The IMU sensor 130 may include three accelerometers configured to measure accelerations of the x-axis, the y-axis, and the z-axis, respectively, and three gyroscopes configured to measure gyro values of the x-axis, the y-axis, and the z-axis, respectively.

A processor 150 compares the magnetic field measured by the magnetic field sensor 120 to a magnetic field map stored in a memory. The processor 150 estimates the location of user terminal 100 to be a point, on the magnetic field map, at which a magnetic field is identical to or most similar to the magnetic field measured by the magnetic field sensor 120, among points on the magnetic field map.

However, if the user terminal 100 tilts when the magnetic field sensor 120 measures the magnetic field, the measured magnetic field may include a tilt error. The term “tilt error” refers to an error in the measured magnetic field that is generated by the tilt of the magnetic field sensor 120. The tilt error may be expressed by angles of rotation with respect to the respective three axes as central axes. The angles of rotation may be expressed by pitch, roll, and yaw, respectively.

In order to estimate the location of the user terminal 100, the processor 150 may employ one or more localization methods, for example, a Kalman filter, a particle filter, a Markov localization, and/or other methods known to one of ordinary skill in the art. The aforementioned methods are known to one of ordinary skill in the art, and thus, a detailed description will be omitted herein. The user terminal 100 may apply data measured by the resources to the localization methods, thereby providing indoor and outdoor location information to a user.

However, a change in a state of the user terminal 100 may occur. For example, the user may receive a phone call, hold the user terminal 100 to an ear of the user, and start talking, while the application that provides the service of estimating the location is being executed. Accordingly, a change in, for example, electromagnetic waves, a magnetic field, and/or a location, of the user terminal 100, may occur. In addition, the change in the state of the user terminal 100 may affect a number of the resources to be used to provide the service.

In this example, the change in the location of the user terminal 100 may cause an interference in a height and/or a tilt that are measured by the user terminal 100. A human body may increase a signal interference in the user terminal 100 that may cause an interference in a wireless fidelity (WiFi) signal transceived by the user terminal 100. In addition, a movement of the human body may block a light of the user terminal 100, e.g., may cause an interference in a light emitting diode (LED) light source of the user terminal 100.

In another example, the user may execute a game application, which consumes a great amount of power, while the application that provides the service of estimating the location is being executed. Accordingly, a change in a state of the user terminal 100 may occur, affecting a number of the resources to be used to provide the service, and/or causing an interference in the service. In this example, the rapid power consumption in the processor 150 may interfere with the magnetic field measured by the magnetic field sensor 120.

As described above, if the state of the user terminal 100 is changed by internal and external factors while the application is being executed, data measured by the resources may include an error. Accordingly, the estimated location of the user terminal 100 may include an error.

According to examples described herein, whether an interference in the service of the application occurs may be determined by sensing a change in the state of the user terminal 100. In addition, data measured by resources affected by the change in the state of the user terminal 100 may be filtered (e.g., removed), whereby a more accurate service of estimating the location may be provided.

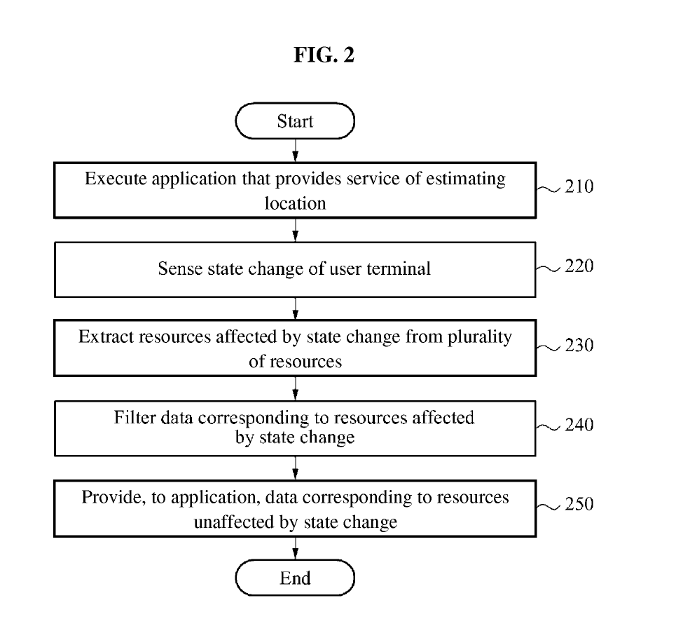

FIG. 2 is a flowchart illustrating an example of a method of providing a service of estimating a location based on a change in a state of a user terminal. Referring to FIG. 2, in operation 210, the user terminal executes an application that provides the service of estimating the location.

In operation 220, the user terminal senses a change in the state of the user terminal while the application is being executed. The change in the state of the user terminal may include, for example, a change in a power consumption occurring in an internal processor of the user terminal, a change in an internal state including a change in a function performed in the user terminal, a change in a magnetic field interference occurring in an external portion of the user terminal, a change in a location of a light source, and/or a change in an external state including a change in the location of the user terminal, while the application is being executed. The change in the function performed in the user terminal may include, for example, transmitting a text message, transmitting an image (e.g., a photo and/or a video), executing a game application, viewing digital multimedia broadcasting (DMB), and/or other functions known to one of ordinary skill in the art.

In operation 230, the user terminal extracts one or more resources affected by the sensed change in the state of the user terminal from a plurality of resources to be used to provide the service of the application. The plurality of resources may include, for example, at least two of a magnetic field sensor configured to measure a magnetic field at the location of the user terminal, an acceleration sensor configured to measure an acceleration of the user terminal, an IMU sensor configured to measure an acceleration and a gyro value of the user terminal, and an optical sensor configured to measure a light-intensity with respect to the user terminal.

In operation 240, the user terminal filters (e.g., removes) data corresponding to the extracted resources affected by the change in the state of the user terminal from data corresponding to the plurality of resources, to generate data corresponding to one or more resources unaffected by the change in the state of the user terminal, among the plurality of resources. In other words, the user terminal extracts the data corresponding to the resources unaffected by the change in the state of the user terminal from the data corresponding to the plurality of resources.

In operation 250, the user terminal provides, to the application, the generated data corresponding to the resources unaffected by the change in the state of the user terminal. In other words, the user terminal provides, to the application, the data corresponding to the resources unaffected by the change in the state of the user terminal that is extracted from the data corresponding to the plurality of resources.

For example, a user may receive a phone call, and may hold the user terminal to an ear of the user, while the application is being executed. Accordingly, the user terminal may sense a change in, for example, electromagnetic waves, a magnetic field, and/or the location, of the user terminal. The change of the state of the user terminal may cause an interference, and the application may likely estimate an incorrect place to be the location of the user terminal.

Accordingly, the user terminal may extract an LED light source and the magnetic field sensor that are greatly interfered by the sensed change of the state of the user terminal, from the plurality of resources to be used to provide the service of the application. The user terminal may filter (e.g., remove) data obtained from the LED light source and the magnetic field sensor, from data corresponding to the plurality of resources, to generate data obtained from the IMU sensor and a WiFi signal that are least interfered by the change in the state of the user terminal, among the plurality of resources. The user terminal may provide, to the application, the data obtained from the IMU sensor and the WiFi signal, thereby enabling the application to estimate the location of the user terminal.

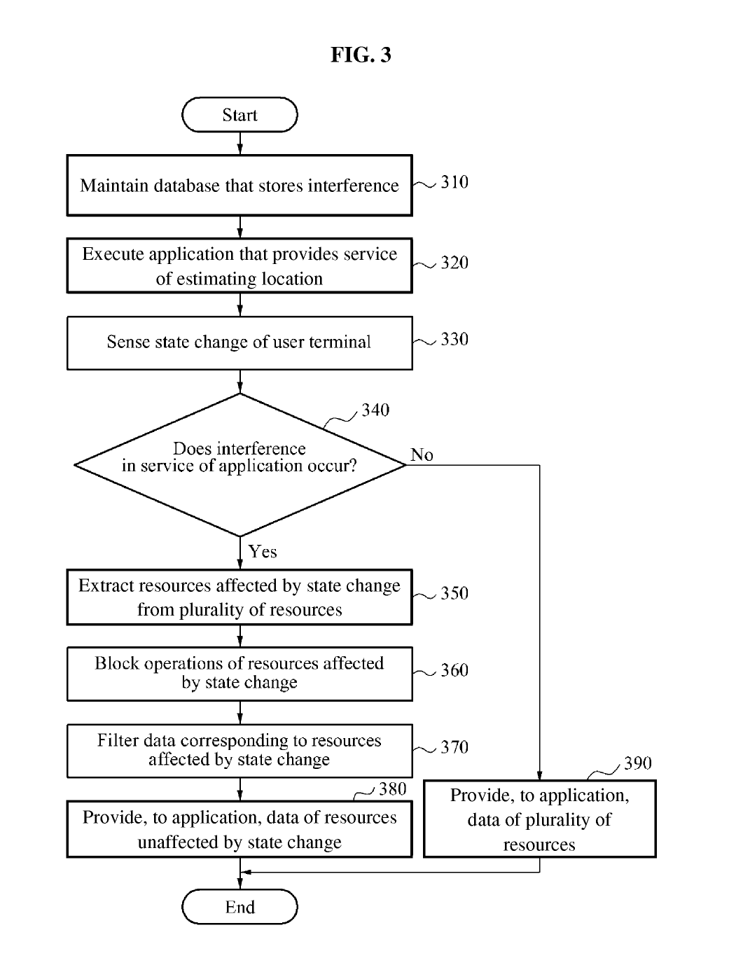

FIG. 3 is a flowchart illustrating another example of a method of providing a service of estimating a location based on a change in a state of a user terminal. Referring to FIG. 3, in operation 310, the user terminal maintains a database that stores in advance at least one interference corresponding to a change in the state of the user terminal while an application that provides the service of estimating the location is being executed.

In operation 320, the user terminal executes the application that provides the service of estimating the location.

In operation 330, the user terminal senses a change in the state of the user terminal while the application is being executed.

In operation 340, the user terminal determines whether an interference in the service of the application occurs based on the sensed change in the state of the user terminal and the maintained database. The interference may affect the location of the user terminal to be estimated by the application. Even if the interference occurs, the user terminal may determine that no interference occurs if an actually-estimated location of the user terminal is within a predetermined margin of error.

For example, the user terminal may execute a game application while the application that provides the service of estimating the location is being executed. Accordingly, the user terminal may sense a change in the state of the user terminal, for example, a change in a power consumption in an internal processor of the user terminal, and a change in the location of the user terminal. In this example, an interference occurring in the user terminal due to the change in the power consumption and/or the location, of the user terminal, may be stored in advance in the database, and may be matched to the sensed change in the state of the user terminal to determine that the interference occurs. For example, a magnetic field interference caused by the change in the power consumption in the internal processor if the game application is executed, an interference in an amount of light entering an optical sensor, and/or an interference caused by a rapid movement of the user terminal, may be stored in advance in the database, any may be matched to the sensed change in the state of the user terminal to determine that the interferences occur.

In another example, a user may press a call button, may hold the user terminal to an ear, and may start talking. In this example, the change in the location of the user terminal may cause an interference in a height and/or a tilt that are measured by the user terminal. A human body may increase a signal interference in the user terminal that may cause an interference in a WiFi signal transceived by the user terminal In addition, a movement of the human body may block a light of the user terminal, e.g., may cause an interference in a LED light source of the user terminal. All of the aforementioned interferences may be stored in advance in the database, and may be matched to the change in the state of the user terminal to determine that the interferences occur.

In other words, in operation 340, the user terminal determines whether an interference in the service of the application occurs based on whether an interference corresponding to the sensed change in the state of the user terminal is stored in advance in the maintained database. If interference in the service of the application occurs, the method continues in operation 350. Otherwise, the operation continues in operation 390.

In operation 350, the user terminal extracts one or more resources affected by the sensed change in the state of the user terminal from a plurality of resources to be used to provide the service of the application.

In operation 360, the user terminal blocks operations of the extracted resources affected by the change in the state of the user terminal.

In operation 370, the user terminal filters (e.g., removes) data corresponding to the extracted resources affected by the change in the state of the user terminal from data corresponding to the plurality of resources, to generate data corresponding to one or more resources unaffected by the change in the state of the user terminal, among the plurality of resources.

In operation 380, the user terminal provides, to the application, the generated data of the resources unaffected by the change in the state of the user terminal.

In operation 390, the user terminal provides, to the application, the data of the plurality of resources.

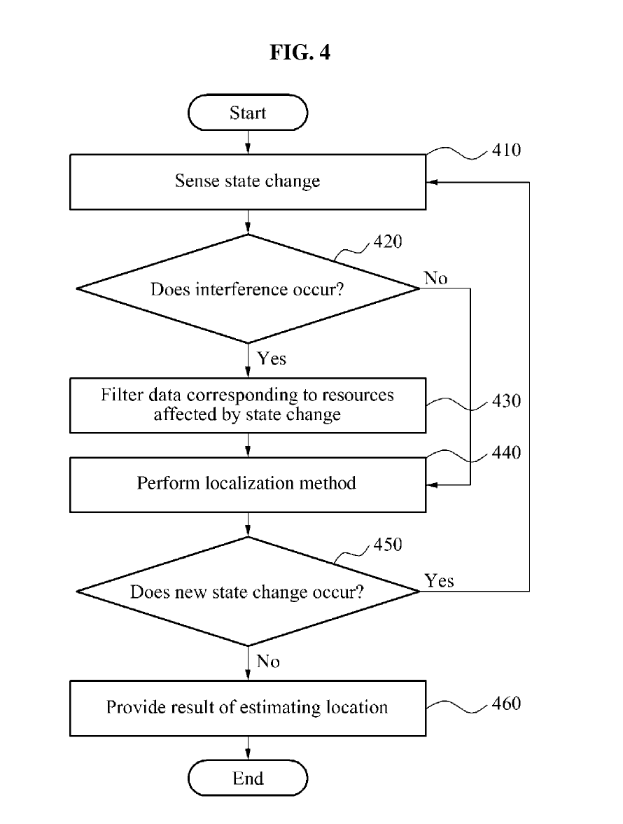

FIG. 4 is a flowchart illustrating still another example of a method of providing a service of estimating a location based on a change in a state of a user terminal. Referring to FIG. 4, in operation 410, the user terminal senses a change in the state of the user terminal while an application that provides the service of estimating the location is being executed.

In operation 420, the user terminal determines whether an interference in the service of the application occurs based on the sensed change in the state of the user terminal. If interference in the service of the application occurs, the method continues in operation 430. Otherwise, the operation continues in operation 440.

In operation 430, the user terminal filters (e.g., removes) data corresponding to one or more resources affected by the sensed change in the state of the user terminal from data corresponding to a plurality of resources to be used to provide the service of the application, to generate data corresponding to one or more resources unaffected by the sensed change in the state of the user terminal, among the plurality of resources.

In operation 440, the user terminal performs a localization method of estimating the location of the user terminal. The user terminal may perform the localization method based on the generated data corresponding to the resources unaffected by the change in the state of the user terminal, or the data corresponding to the plurality of resources.

In operation 450, the user terminal senses whether a new change in the state of the user terminal occurs, the new change being distinct from the sensed change in the state of the user terminal. If the new change in the state of the user terminal does not occur, the method continues in operation 460. Otherwise, the method returns to operation 410.

In operation 460, the user terminal provides a result of the estimating of the location of the user terminal. For example, the user terminal may provide a user with the result of the estimating of the location based on the generated data corresponding to the resources unaffected by the change in the state of the user terminal.

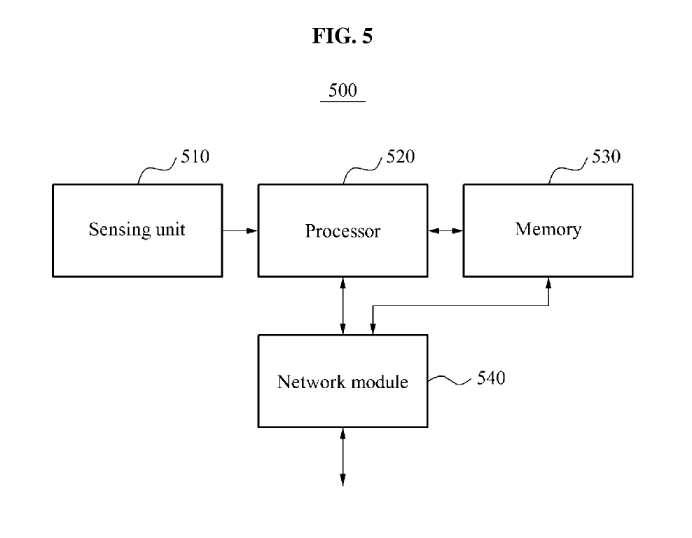

FIG. 5 is a block diagram illustrating another example of a user terminal 500 that provides a service of estimating a location based on a change in a state of the user terminal. Referring to FIG. 5, the user terminal 500 includes a sensing unit 510, a processor 520, a memory 530, and a network module 540.

The sensing unit 510 senses a change in the state of the user terminal 500 while an application that provides the service of estimating the location is being executed. The change in the state of the user terminal may include, for example, a change in a power consumption occurring in an internal processor of the user terminal 500, a change in an internal state including a change in a function performed in the user terminal 500, a change in a magnetic field interference occurring in an external portion of the user terminal 500, a change in a location of a light source, and/or a change in an external state including a change in the location of the user terminal 500, while the application is being executed.

The processor 520 extracts one or more resources affected by the sensed change in the state of the user terminal 500 from a plurality of resources to be used to provide the service of the application. For example, the plurality of resources may include at least two of a magnetic field sensor configured to measure a magnetic field at the location of the user terminal 500, an acceleration sensor configured to measure an acceleration of the user terminal 500, an IMU sensor configured to measure an acceleration and a gyro value of the user terminal 500, and an optical sensor configured to measure a light-intensity with respect to the user terminal 500. The processor 520 further filters (e.g., removes) data corresponding to the extracted resources affected by the change in the state of the use terminal, from data corresponding to the plurality of resources, to generate data corresponding to one or more resources unaffected by the change in the state of the user terminal, among the plurality of resources. In other words, the processor 520 extracts the data corresponding to the resources unaffected by the change in the state of the user terminal from the data corresponding to the plurality of resources. The processor 520 further provides, to the application, the generated data corresponding to the resources unaffected by the change in the state of the user terminal. The application estimates the location of the user terminal based on the provided data corresponding to the resources unaffected by the change in the state of the user terminal.

In addition, the sensing unit 510 may sense whether a new change in the state of the user terminal 500 occurs after the processor 520 provides, to the application, the generated data corresponding to the resources unaffected by the change in the state of the user terminal The new change is distinct from the sensed change in the state of the user terminal 500.

The processor 520 may provide a user with a result of the estimating of the location based on whether the new change in the state of the user terminal 500 occurs. If the new change in the state of the user terminal 500 does not occur, the processor 520 may provide the user with the result of the estimating of the location. If the new change in the state of the user terminal 500 occurs, the processor 520 may extract one or more resources affected by the new change in the state of the user terminal 500 from the plurality of resources. The processor 520 may further filter data corresponding to the extracted resources affected by the new change in the state of the use terminal, from the data corresponding to the plurality of resources, to generate data corresponding to resources unaffected by the new change in the state of the user terminal, among the plurality of resources. The processor 520 may further provide, to the application, the generated data corresponding to the resources unaffected by the new change in the state of the user terminal.

In addition, the processor 520 may determine whether an interference in the service of the application occurs based on the sensed change in the state of the user terminal 500. In more detail, the processor 520 may determine an interference in the service of the application based on whether an interference corresponding to the sensed change in the state of the user terminal 500 is stored in advance in a database. The processor 520 may further block operations of the extracted resources affected by the change in the state of the user terminal 500.

The memory 530 maintains the database in which at least one interference corresponding to a change in the state of the user terminal 500 is stored in advance. In addition, the memory 530 may store information associated with a magnetic field map.

The magnetic field map includes one or more magnetic fields measured in advance at respective positions included in a region of a predetermined range, for example, a region in which the location of the user terminal 500 is to be estimated. The positions may be spaced at respective predetermined distances, and/or may include places in which respective magnetic fields may be measured or places that the user terminal 500 may reach.

Further, the positions may be in a three-dimensional (3D) space, as opposed to a two-dimensional (2D) plane. For example, the user terminal 500 may be used to estimate an indoor location, for example, an inside of a high-rise building. The user terminal 500 may measure magnetic field at a fixed position on each floor of the high-rise building, so that all positions are viewed to be identical on a 2D floor plan. Although all of the positions may be viewed to be identical on the 2D floor plan, heights of the respective positions may differ from one another in a 3D space. Accordingly, magnetic fields measured on respective floors of the high-rise building may differ from one another.

In addition, the memory 530 may store magnetic field maps corresponding to respective regions. For example, the memory 530 may store the magnetic field maps so that the user terminal 500 may estimate the location of the user terminal 500 in the regions. The regions may include respective floors of a high-rise building.

The network module 540 provides the user terminal 500 with information from a server, and/or other information known to one of ordinary skill in the art, and provides or transmits the result of the estimating of the location of the user terminal 500 to the user, the server and/or other elements known to one of ordinary skill in the art. The information from the server may include, for example, updated map information, a magnetic field map, and/or a database in which at least one interference corresponding to a change in the state of the user terminal 500 is stored in advance.

The units described herein may be implemented using hardware components, software components, or a combination thereof. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, that independently or collectively instructs or configures the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable recording mediums.

The computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, and optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing a service of estimating a location, the method comprising:
sensing a change in a state of a terminal while an application that provides the service of estimating the location is being executed;
extracting one or more resources affected by the change from a plurality of resources to be used to provide the service;
filtering data corresponding to the one or more affected resources; and
providing data to the application based on the filtering.

2. The method of claim 1, further comprising:
filtering the data corresponding to the one or more affected resources from data corresponding to the plurality of resources, to generate data corresponding to one or more resources unaffected by the change, among the plurality of resources.

3. The method of claim 2, further comprising:
providing, to the application, the data corresponding to the one or more unaffected resources.

4. The method of claim 1, further comprising:
determining whether an interference in the service occurs based on the change.

5. The method of claim 1, further comprising:
maintaining a database that stores an interference in the service that corresponds to the change.

6. The method of claim 5, further comprising:
determining that the interference occurs based on the change and the database.

7. The method of claim 1, further comprising:
blocking operations of the one or more affected resources.

8. The method of claim 1, further comprising:
sensing whether a new change in the state occurs after the providing of the data, the new change being distinct from the change.

9. The method of claim 8, further comprising:
providing a result of the estimating of the location based on whether the new change occurs.

10. The method of claim 1, wherein the change comprises a change in a power consumption occurring in an internal processor of the terminal, or a change in an internal state comprising a change in a function performed in the terminal, or a change in a magnetic field interference occurring in an external portion of the terminal, or a change in a location of a light source, or a change in an external state comprising a change in the location of the terminal, or any combination thereof.

11. The method of claim 1, wherein the plurality of resources comprises at least two of a magnetic field sensor that measures a magnetic field at the location of the terminal, an acceleration sensor that measures an acceleration of the terminal, an inertial measurement unit (IMU) sensor that measures an acceleration and a gyro value of the terminal, and an optical sensor that measures a light-intensity with respect to the terminal.

12. A non-transitory computer-readable storage medium storing a program comprising instructions to cause a computer to perform the method of claim 1.

13. A terminal comprising:
a sensing unit configured to sense a change in a state of the terminal while an application that provides a service of estimating a location is being executed; and
a processor configured to
extract one or more resources affected by the change from a plurality of resources to be used to provide the service,
filter data corresponding to the one or more affected resources, and
provide data to the application based on the filtering.

14. The terminal of claim 13, wherein the processor is further configured to:
filter the data corresponding to the one or more affected resources from data corresponding to the plurality of resources, to generate data corresponding to one or more resources unaffected by the change, among the plurality of resources.

15. The terminal of claim 14, wherein the processor is further configured to:
provide, to the application, the data corresponding to the one or more unaffected resources.

16. The terminal of claim 13, further comprising:
a memory configured to maintain a database that stores an interference in the service that corresponds to the change.

17. The terminal of claim 16, wherein the processor is further configured to:
determine that the interference occurs based on the change and the database.

18. The terminal of claim 13, wherein the processor is further configured to:
block operations of the one or more affected resources.

19. The terminal of claim 13, wherein the sensing unit is further configured to:
sense whether a new change in the state occurs after the providing of the data, the new change being distinct from the change.

20. The terminal of claim 19, further comprising:
a network module configured to provide a result of the estimating of the location based on whether the new change occurs.

21. An apparatus comprising:
a processor configured to
sense a change in the apparatus,
extract, from data corresponding to a plurality of resources, data corresponding to one or more resources unaffected by the change, among the plurality of resources, and
estimate a location of the apparatus based on the data corresponding to the one or more unaffected resources.

22. The apparatus of claim 21, wherein the plurality of resources comprises at least two sensors configured to measure the data corresponding to the plurality of resources.
